(19) United States
(12) Patent Application Publication
(10) Pub. No.: US 2007/0014544 A1
(43) Pub. Date: Jan. 18, 2007

(54) Apparatus for reproducing data, method thereof, recording medium, apparatus for recording data and method thereof

(75) Inventor: Kun Suk Kim, Anyang-si (KR)

Correspondence Address: HARNESS, DICKEY & PIERCE, P.L.C., P.O. BOX 8910, RESTON, VA, 20195, US

(73) Assignee: LG Electronics Inc.

(21) Appl. No.: 11/481,934

(22) Filed: Jul. 7, 2006

Related U.S. Application Data
(60) Provisional application No. 60/699,404, filed on Jul. 15, 2005.

(30) Foreign Application Priority Data
May 25, 2006 (KR) 10-2006-0046973

(51) Int. Cl. H04N 7/26

(52) U.S. Cl. 386/112

(57) ABSTRACT

An apparatus for reproducing data, method thereof, recording medium, apparatus for recording data and method thereof are disclosed, by which a seamless reproduction between a plurality of contents within the recording medium can be implemented. A method for reproducing a plurality of contents within a recording medium successively, the method comprises first reproducing a first contents among the contents; allocating a buffer for seamless reproduction of a second contents in case that seamless information recorded on the recording medium indicates that the second contents is seamlessly reproduced after the first contents is reproduced; pre-loading the second contents from the recording medium to the buffer; and second reproducing the second contents pre-loaded in the buffer.

This application claims the benefit of Korean Patent Application No. 10-2006-0046973, filed on May 25, 2006, which is hereby incorporated by reference as if fully set forth herein.

This application claims the benefit of the U.S. Provisional Application No. 60/699,404, filed on Jul. 15, 2005, in the name of inventor Kun Suk KIM, entitled “SEAMLESS PLYBACK MECHANISM IN VIDEO PLAYER”, which is hereby incorporated by reference as if fully set forth herein.

### BACKGROUND OF THE INVENTION

1. Field of the Invention

The present invention relates to an apparatus for reproducing data, method thereof, recording medium, apparatus for recording data and method thereof.

2. Discussion of the Related Art

Generally, optical discs capable of recording large-scale data as record media are widely used. Recently, a new high-density record medium, e.g., Blu-ray disc (hereinafter abbreviated BD) or HD-DVD (high definition digital versatile disc) has been developed to store video data of high image quality and audio data of high sound quality for long duration.

The development of the high-density recording medium enables networking with an external environment of the recording medium, a combined reproduction function between data stored in the recording medium and data stored outside the recording medium. And, this development enables data having interactivity with user considerably surpassing that of a conventional recording medium.

Recently, many efforts are made to develop an optical recording/reproducing apparatus enabling reproductions of data within the high-density recording medium and data existing outside the recording medium.

However, high-density medium specifications, which regulate connection between an optical recording/reproducing apparatus and a peripheral device and association between a high-density recording medium and a storage storing data associated with the high-density recording medium, has not been completed, which causes difficulty in developing the optical recording/reproducing apparatus.

Specifically, in successively reproducing a plurality of contents within the high-density recording medium, any preferable method for implementing the seamless reproduction between the contents has not been known, whereby many limitations are put on the full-scale development of a high-density recording medium based optical recording/reproducing apparatus.

### SUMMARY OF THE INVENTION

Accordingly, the present invention is directed to an apparatus for reproducing data, method thereof, recording medium, apparatus for recording data and method thereof that substantially obviate one or more problems due to limitations and disadvantages of the related art.

An object of the present invention is to provide an apparatus for reproducing data, method thereof, recording medium, apparatus for recording data and method thereof, by which a seamless reproduction between contents within the recording medium can be implemented.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for reproducing a plurality of contents within a recording medium successively, the method comprises first reproducing a first contents among the contents allocating a buffer for seamless reproduction of a second contents in case that seamless information recorded on the recording medium indicates that the second contents is seamlessly reproduced after the first contents is reproduced; pre-loading the second contents from the recording medium to the buffer; and second reproducing the second contents pre-loaded in the buffer.

The buffer can be allocated according to buffer size information for the seamless reproduction.

The buffer can be allocated to a data cache within a player.

In another aspect of the present invention, an apparatus for reproducing a plurality of contents within a recording medium successively, the apparatus comprises a pickup reading data from the recording medium; and a controller controlling a first contents among the contents to be reproduced, the controller allocating a buffer for seamless reproduction of a second contents in case that seamless information recorded on the recording medium indicates that the second contents is seamlessly reproduced after the first contents is reproduced, the controller pre-loading the second contents from the recording medium to the buffer; and controlling the second contents pre-loaded in the buffer to be reproduced.

The controller can allocate the buffer according to buffer size information for the seamless reproduction.

The controller can allocate the buffer to a data cache within a player.

In another aspect of the present invention, a recording medium comprises a stream area on which a plurality of contents is recorded; and a management area on which reproduction management information of the contents is recorded, wherein the reproduction management information includes seamless information indicating whether or not the contents is seamlessly reproduced.

The seamless information can be defined for each of the contents.

The reproduction management information can further include buffer size information for seamless reproduction of the contents.

The buffer size information can be defined for each of the contents.

In another aspect of the present invention, a method of recording data, comprises recording a plurality of contents on a recording medium; and recording reproduction management information for the contents, wherein the reproduction management information includes seamless information indicating whether or not the contents is seamlessly reproduced.

The reproduction management information can further include buffer size information for seamless reproduction of the contents.

The buffer size information can be included in the reproduction management information in case that the seamless information indicates that the contents is seamlessly reproduced.

In another aspect of the present invention, an apparatus for recording data comprises a recording unit recording a plurality of contents on a recording medium; and a controller generating reproduction management information including seamless information indicating whether or not the contents is seamlessly reproduced, the controller controlling the recording unit to record the reproduction management information on the recording medium.

The reproduction management information can further include buffer size information for seamless reproduction of the contents.

The buffer size information can be included in the reproduction management information in case that the seamless information indicates that the contents is seamlessly reproduced.

Therefore, the present invention enables a plurality of contents associated with a recording medium to be reproduced continuously and seamlessly.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an exemplary diagram for explaining a combined use between an optical recording/reproducing apparatus and peripheral devices;

FIG. 2 is a block diagram of an optical recording/reproducing apparatus according to one embodiment of the present invention;

FIG. 3 is a block diagram of a contents structure according to one embodiment of the present invention;

FIG. 4 is a diagram of a data recording structure recorded on an optical disc according to the present invention;

FIG. 5 is a block diagram of an overall system model for contents of the present invention;

FIG. 6 is a diagram of seamless information according to one embodiment of the present invention;

FIG. 7 is a flowchart of a data reproduction using seamless information;

FIG. 8 is a diagram of buffer size information for a seamless reproduction between contents according to one embodiment of the present invention; and

FIG. 9 is a flowchart of a data reproduction using buffer size information for a seamless reproduction between contents.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

First of all, for convenience of explanation, the present invention takes an optical disc, and more particularly, “HD-DVD” as an example of a record medium. Yet, it is apparent that the technical idea of the present invention is identically applicable to other record media.

In the present invention, contents which constructs a title means data provided by an author of a recording medium or a contents provider.

And, a provider, who provides contents as an internal input source, is collectively named a contents provider (CP).

In the present invention, a title, which is one complete contents unit, means a reproduction unit configuring an interface with a user. The tile can be selected by a title menu or can be indicated using a title.

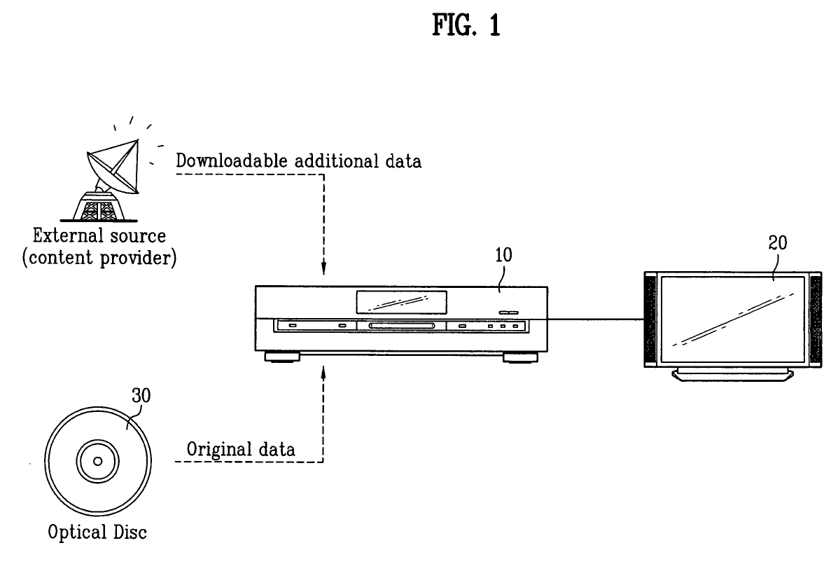

In the present invention, “persistent storage” is a sort of a storage means provided to or connected to an optical recording/reproducing apparatus shown in FIG. 1 and means a storage device storing data having persistency. The persistent storage can be classified into two categories. The first category includes a ‘required persistent storage’ like a flash memory provided within an optical recording/reproducing apparatus. And, the second category includes ‘additional persistent storage’ connectible to or removable from an optical recording/reproducing apparatus like a USB memory, HDD memory or memory card.

The persistent storage is utilized as a means for storing data associated with a recording medium. And, the data stored in the persistent storage by being associated with the recording medium is externally downloaded in general. Besides, data can be stored in the persistent storage by being directly read from a recording medium.

For the convenience of explanation of the present invention, the data recorded within the record medium shall be named “original data” and the data associated with the record medium among the data stored within the persistent storage shall be named “additional data”. This is for the convenience of explanation. The original data and the additional data are discriminated from each other only according to a method of obtaining data each. So, the original or additional data is not always limited to specific data. So, if data exists outside an optical disc, any data having an attribute associated with original data is possible as additional data.

FIG. 1 is an exemplary diagram for explaining a combined use between an optical recording/reproducing apparatus 10 and peripheral devices to facilitate conceptual understanding of the present invention.

Referring to FIG. 1, “optical recording/reproducing apparatus” 10 according to the present invention enables a record or reproduction of an optical disc according to various specifications. And, the optical recording/reproducing apparatus 10 can be designed to record/reproduce an optical disc (e.g., HD-DVD) of a specific specification. And, it is apparent that the “optical recording/reproducing apparatus” 10 includes “driver” loadable within a computer or the like.

The optical recording/reproducing apparatus 10 according to the present invention is equipped with a function of recording/reproducing an optical disc 30 and a function of receiving an external input signal, performing signal-processing on the received signal, and delivering a corresponding image to a user via another external display 20. In this case, no limitation is put on the external input signal. And, a DMB (digital multimedia broadcast) signal, an Internet signal or the like can be a representative one of the external input signals. In case of Internet as an easily accessible medium, a specific data on Internet can be downloaded via the optical recording/reproducing apparatus 10 to be utilized.

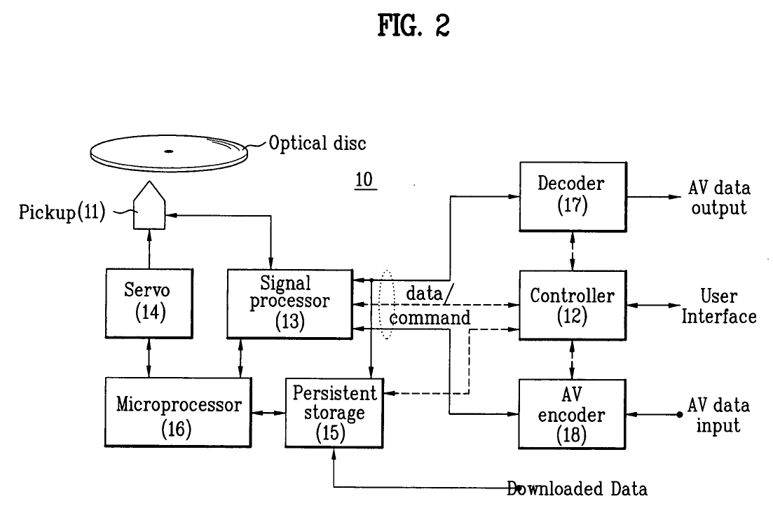

FIG. 2 is a block diagram of an optical recording/reproducing apparatus 10 according to one embodiment of the present invention.

Referring to FIG. 2, an optical recording/reproducing apparatus according to one embodiment of the present invention basically includes a pickup 11 for reproducing management information including original data and reproduction management file information recorded in an optical disc, a servo 14 controlling an action of the pickup 11, a signal processor 13 restoring a reproduction signal received from the pickup 11 to a specific signal value, modulating a signal to be recorded into a signal recordable on the optical disc, and delivering the modulated signal, and a microprocessor 16 controlling the overall operations.

The controller 12 controls additional data, which exists outside an optical disc and is downloaded, to be stored in a persistent storage 15 according to a user's command or the like and controls to manage the persistent storage 15 and an application accessing the persistent storage 15.

In the present invention, an application is a sort of an execution unit and includes a program designed to enable a user or another application to directly perform a specific function. The application officially makes a request for a job to another program or communicates with another program using API (application programming interface). The application may exist within a recording medium or a persistent storage.

In case that a request for reproducing a plurality of contents recorded within the recording medium 30 continuously is made, the controller 12 of the present invention is able to control the contents within the recording medium 30 continuously and seamlessly. This continuous reproduction of a plurality of contents is called scene medleys.

If there is a request for a continuous reproduction of a plurality of scenes, titles or the like, it is not supported that contents data recorded in a non-neighbor area is seamlessly read by one pickup 11. So, how to guarantee a seamless transition between the contents to be reproduced is a serious problem.

To solve this problem, the controller 12 of the present invention checks information that indicates whether or the contents is seamlessly reproduced or not. Hereinafter, suppose that two contents to be reproduced successively are called the current contents and the next contents.

If the information indicates the seamless reproduction of the contents, the controller 12 allocates a buffer for the seamless reproduction to a memory area of the optical recording/reproducing apparatus 10. In this case, the buffer for the seamless reproduction can be allocated large enough to implement the seamless reproduction of the entire contents to be reproduced or can be reallocated to have a size suitable for a seamless reproduction of a next contents each time a contents is reproduced.

The controller 12 controls the contents to be next reproduced to be read from the recording medium and to be stored in the buffer.

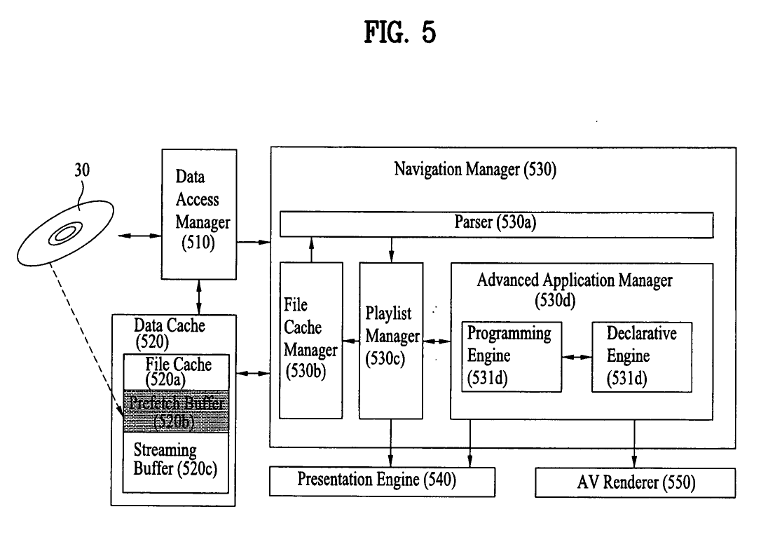

Once a reproduction of current contents is completed, the next contents stored in the buffer is controlled to be reproduced. The contents is directly reproduced from the buffer or from a file cache (cf. ‘520a’ in FIG. 5) after having been loaded in the file cache.

The controller 12 can check buffer size information, which is recorded on the recording medium, for a seamless reproduction and is then able to allocate a buffer for a seamless reproduction to the optical recording/reproducing apparatus 10 according to the buffer size information.

Besides, the buffer for the seamless reproduction can be allocated to an area defined as a memory already provided to the optical recording/reproducing apparatus 10 such as ‘Data Cache 520’ shown in FIG. 5. Alternatively, the buffer for the seamless reproduction can be defined as a separate intrinsic area.

An AV decoder 17 finally decodes output data under the control of the controller 12 and then provides the decoded data to a user.

In order to perform a function of recording a signal in the optical disc, an AV encoder 18 converts an input signal to a signal of a specific format, e.g., an MPEG2 transport stream according to a control of the controller 12 and then provides the converted signal to the signal processor 13.

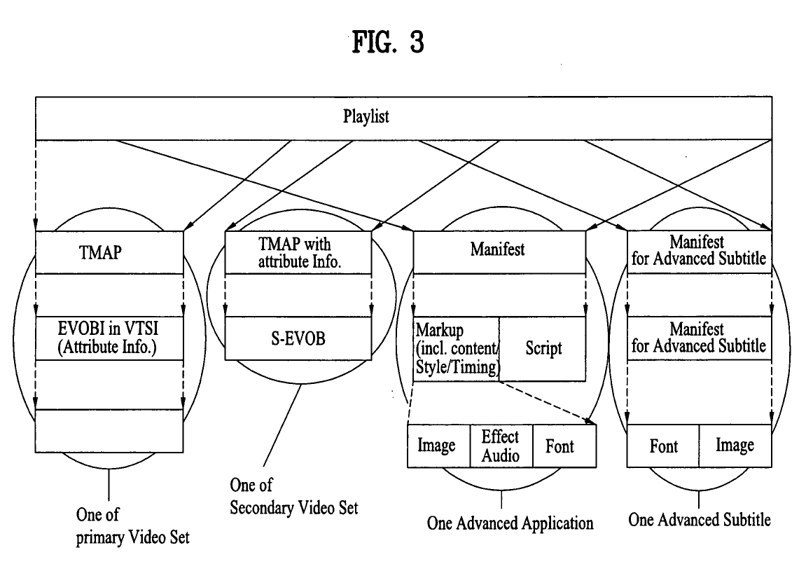

FIG. 3 is a block diagram of a contents structure according to one embodiment of the present invention.

Referring to FIG. 3, it is able to classify contents into standard content and advanced content. Standard content consists of navigation data and video object data on a recording medium and is just extension for high-resolution video, high-quality audio and several new functions. Advanced content realizes more interactivity in addition to the extension of audio and video realized by standard content.

Advanced content is constructed with an advanced navigation including a playlist, a manifest, a markup and script files and advanced data including primary video set, secondary video set, advanced application and advanced subtitle.

The playlist provides reproduction information between presentation objects including primary video set, secondary video set, advanced application and advanced subtitle.

For instance, in order to reproduce primary video set, the optical recording/reproducing apparatus 10 reads a time map (TMAP) using information (e.g., URI) described in the playlist, interprets enhanced video object information (EVOBI) referred by the time map, and then accesses a proper primary enhanced video object (P-EVOB) defined in the enhanced video object information.

In order to reproduce the secondary video set, the optical recording/reproducing apparatus 10 interprets the time map read using the URI described in the playlist and then accesses a secondary enhanced video object (S-EVOB) defined in the time map.

In order to present the advanced application, the optical recording/reproducing apparatus 10 reads a manifest file using information described in the playlist, stores resources defined in the manifest file and then starts a presentation of an initial markup file represented by the manifest file. Namely, the optical recording/reproducing apparatus 10 interprets the playlist to reproduce advanced content according to the present invention.

In order to present advanced subtitle, the optical recording/reproducing apparatus 10 according to the present invention reads a manifest file for advanced application, stores resources defined n the manifest file, and then starts a presentation of an initial markup file described in the manifest file.

In particular, in reproducing advanced content, a playlist is used for two purposes. One is for an initial system configuration of an optical recording/reproducing apparatus and the other is to define how to present various kinds of presentation objects of the advanced content.

The playlist is configuration information for the advanced content reproduction and includes object mapping information, track number assignment information, track navigation information, resource information, reproduction sequence information and system configuration information.

The object mapping information gives reproduction information between presentation objects by mapping the presentation objects such as primary video set (main audio video), secondary video set (substitute audio video/substitute audio/secondary audio video), advanced application and advanced subtitle to a title timeline assigned to each title. In this case, the title timeline means a virtual timeline for a title. A progress of time on a title timeline can be changed by a reproduction mode (e.g., normal play, pause, jump, etc.).

The presentation objects mapped to the title timeline are presented according to a time progress of the title timeline and valid periods of the presentation objects. In this case, the valid period of the presentation object means a presentation time interval within a title timeline for the presentation object. If resources are provided and if a specific condition is met, the presentation object is presented for the valid period only. In the object mapping information, the primary video set or the secondary video set can be referred to by URI (uniform resource identifier) of its time map file. And, the advanced application or the advanced subtitle can be referred to by URI of the manifest file.

In the track number assignment information, streams within the respective presentation objects and applications, e.g., a main video stream, a main audio stream, a sub video stream, a sub audio stream, a sub-picture stream and advanced application are assigned to tracks. A list of tracks that can be selected by a user from the tracks defined in the track number assignment information is given by the track navigation information. In this case, a track means an elementary stream within a presentation object, which will be selected by an application programming interface (hereinafter abbreviated API) or a user navigation for a reproduction of a title. And, the elementary stream corresponds to one of a coded video bit stream, a coded audio bit stream and other coded bit streams. The track is identified by a track number and can be classified into five types including a video track & sub video track, an audio track, a sub audio track, a subtitle track and an application track. In other words, the track number assignment information indicates what kind of elementary stream within a presentation object is assigned to a track number.

The resource information defines whether prescribed archived data or file is loaded in a file cache within a specific period of a title timeline.

The reproduction sequence information indicates a chapter structure within a title. By indicating time points on a title timeline, a chapter beginning position within a title is defined. A chapter ending position is given by a beginning position of a next chapter or an end of a title timeline for a last chapter. In this case, a chapter means a time segment of a title timeline. A reproduction position can jump to a specific chapter by API or user operation.

And, the system configuration information provides information for a system configuration such as a streaming buffer size. According to the system configuration information, playlist manager 530c changes sizes of a file cache 520a and a streaming buffer 520c within a data cache 520.

In the present invention, the system configuration information is able to include buffer size information for a seamless reproduction. A buffer for a seamless reproduction (hereinafter, prefetch buffer 520b) can be allocated to the data cache 520. In this case, the playlist manager is able to allocate the prefetch buffer to the data cache 520 according to the buffer size information. A size of prefetch buffer is associated with a size of contents data that should be read in advance from a recording medium during a reproduction of current contents for a seamless reproduction between contents. A record medium author estimates a buffer size necessary for a seamless reproduction of continuously reproduced contents and is then able to store the estimated buffer size in a recording medium.

A playlist can include a plurality of titles. Each of a plurality of the titles has a title number. A title number for an advanced navigation is included in a playlist file. A title timeline is assigned to each of a plurality of the titles. And, a valid period of a specific presentation object is decided by a start time and an end time on the title timeline.

Besides, even if there is a reproduction command for a plurality of titles, the present invention is able to guarantee the title-to-title seamless continuous reproduction.

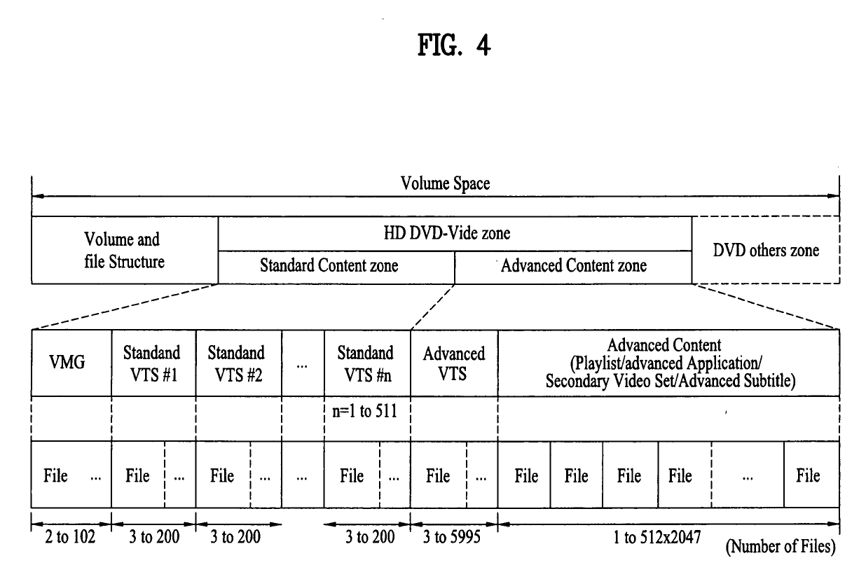

FIG. 4 is a diagram of a data recording structure recorded on an optical disc according to the present invention, in which both ‘standard content’ and ‘advanced content’ are stored in one recording medium.

In the present invention, a recording medium is able to store at least one of ‘standard content’ and ‘advanced content’. Yet, the present invention relates to a reproduction of ‘advanced content’ to provide a function of reproducing a plurality of contents continuously. So, the recording medium of the present invention includes ‘advanced content’.

Referring to FIG. 4, a recording medium according to the present invention has a logical structure that includes a volume space, a video manager (VGM), a video title set (VTS), an enhanced video object set (EVOBS) and advanced content.

A volume structure, which is a data recording structure of a recording medium, includes a volume and file structure allocated for system information to manage entire files of the recording medium, an optical recording medium video zone (hereinafter named HD DVD-Video zone) allocated for data in a high density optical recording medium format and another zone for optical recording medium video applications (hereinafter named DVD others zone).

The HD DVD-Video zone includes standard content zone and/or advanced content zone.

If the recording medium includes the standard content zone, the contents zone includes one video manager (VGM) and at least one video title set.

If the recording medium includes the advanced content zone, the advanced content zone includes files supported by advanced content having an advanced video title set.

Besides, one embodiment is just exemplarily shown in FIG. 4. So, the standard content zone, the advanced content zone and the DVD others zone can be arranged in a manner different from that of the embodiment shown in FIG. 4.

FIG. 5 is a block diagram of an overall system model for contents of the present invention, in which the optical recording/reproducing apparatus of FIG. 2 is shown in aspect of ‘advanced content’.

Referring to FIG. 5, advanced content of the present invention has data sources including a recording medium 30, a persistent storage 15 and a network server.

In this case, a data source is an object that is accessed by an application to perform a specific function. Data within the data source becomes a resource that configures advanced content. And, the advanced content is interpreted by a representation of the resource. And, data exchanges between the data sources and internal modules of the optical recording/reproducing apparatus are controlled by a data access manager 510.

In particular, the data access manager 510 controls data to be read from the recording medium to the internal module or provides file access API set to the recording medium.

The data access manager 510 controls data exchanges between the persistent storage provided or connected to the optical recording/reproducing apparatus 10 and the internal modules of the optical recording/reproducing apparatus 10 and is able to support a file read/write function by providing file access API set for the persistent storage.

The data access manager 510 controls a data exchange between the network server and the internal module of the optical recording/reproducing apparatus 10, and provides file access API set for the network server.

The data access manager 510 is able to provide a file download function and/or a file upload function in general. And, a navigation manager 530 instructs a file download/upload between the network server and a data cache 520 according to advanced application.

The data access manager 510 is able to provide a protocol level access function to a presentation engine 540.

The presentation engine 540 decodes presentation data according to a control command from the navigation manager 530 and then outputs the decoded data to an AV renderer 550.

The AV renderer 550 combines graphic planes coming from the presentation engine 540 and the navigation manager 530 and then outputs the combined planes. And, the AV renderer 550 mixes PCM (pulse code modulation) streams provided from the presentation engine 540 and then outputs the mixed streams.

The data cache 520 is temporary data storage. And, the data cache 520 includes a file cache 520a used as a temporary buffer among the data sources, the navigation manager 530 and the presentation engine 540, and a streaming buffer 520c as a temporary buffer for streaming data.

Information indicating an extent of quota of the data cache 520 for the streaming buffer 520c is included in a playlist. And, the data cache 520 is divided during a startup sequence of advanced content reproduction according to the information.

The data cache 520 is able to include a temporary buffer for a seamless reproduction (prefetch buffer 520b in FIG. 5). Size information of the prefetch buffer can be provided to the optical recording/reproducing apparatus by being included in the playlist. If so, the prefetch buffer will be allocated according to the size information.

The navigation manager is able to control user interfaces such as a remote controller, a front panel of the optical recording/reproducing apparatus, a mouse, a game pad and the like and to process events received from a user interface engine (not shown in the drawing).

And, the navigation manager 530 includes a parser 530a, a playlist manager 530c, an advanced application manager 530d and a file cache manager 539b.

The playlist manager 530c executes startup procedures based on the description in the playlist. The playlist manager 530c initializes all reproduction control modules, controls a title timeline, and plays a role in managing a file cache resource and a reproduction control module, and providing an interface of a player system.

In particular, the playlist manager 530c controls a progress of a title timeline in response to a request from advanced application, a reproduction progress status from each reproduction control module and a default reproduction schedule of a current playlist.

The playlist manager 530c observes whether such a reproduction module, such as a primary video player, a secondary video player and the like is able to maintain a seamless reproduction of a presentation object synchronized with a title timeline. If the synchronized presentation object is unable to maintain a seamless reproduction, the playlist manager 530c adjusts presentation timing between the synchronized presentation objects and time of the title timeline.

The playlist manager 530c reads and parses resource information in object mapping information within a playlist and then provides the resource information to the file cache manager 530b.

The file cache manager 530b generates a resource management table. And, the playlist manager 530c commands the file cache manager 530b to load or discard a resource file, which is based on the table, according to a progress of a title timeline.

The playlist manager 530c manages reproduction control modules by providing various API sets to the programming engine 531d in the advanced application manager 530d and provides an interface of a player system by providing player system APIs such as an APIs accessing system information to the programming engine 531d.

The advanced application manager 530d controls an overall reproduction operation of advanced content and controls the presentation engine 540 in accordance with the cooperation of markup and script of advanced application.

In this case, the advanced application, which is a sort of an application, provides graphics to a graphic and sub-picture plane synchronized with a main video and media reproduced on a sub-video plane or enables interactions between a user and a video reproduction trough such a device as a remote controller.

The advanced application is able to identify each persistent storage and access a corresponding persistent storage. The advanced application is able to read/write/create/delete a file and directory on a persistent storage using a file I/O API. And, the advanced application manages such a network function within the optical recording/reproducing apparatus 10 as an operation of having additional data downloaded from an outside of a recording medium.

Besides, the playlist manager 530c changes a size of the file cache 520a and a size of the streaming buffer 520c. In the present invention, the playlist manager 530c is able to allocate a prefetch buffer 520b to the optical recording/reproducing apparatus 10 for a seamless continuous reproduction of a plurality of contents. The prefetch buffer 530b may be allocated during a startup sequence of advanced content. The size of the prefetch buffer 520b can be assigned suitable for contents that need largest capacity among the reproduced contents. And, the size of the buffer can be changed according to a buffer size necessary for each contents according to progress of reproduction of the contents. For instance, in continuously reproducing a plurality of contents, it is able to change a size of the prefetch buffer 520b for seamless reproduction of next contents during reproduction of current contents.

The optical recording/reproducing apparatus 10 is able to check seamless information indicating whether the contents is seamlessly reproduced or not. In case that the seamless information indicates the contents to be reproduced seamlessly, it is able to allocate the prefetch buffer 520b based on a size of the reproduced contents. Yet, a contents provider can record buffer size information for a contents-to-contents seamless reproduction in a recording medium. In this case, the optical recording/reproducing apparatus 10 is able to allocate the prefetch buffer 520b using the buffer size information.

The seamless information can be defined per contents. And, the buffer size information can be defined per contents as well. In this case, the prefetch buffer 520b can be allocated during a startup sequence of advanced content reproduction according to the largest buffer size information or can be allocated to correspond to buffer size information of each contents in contents reproduction process according.

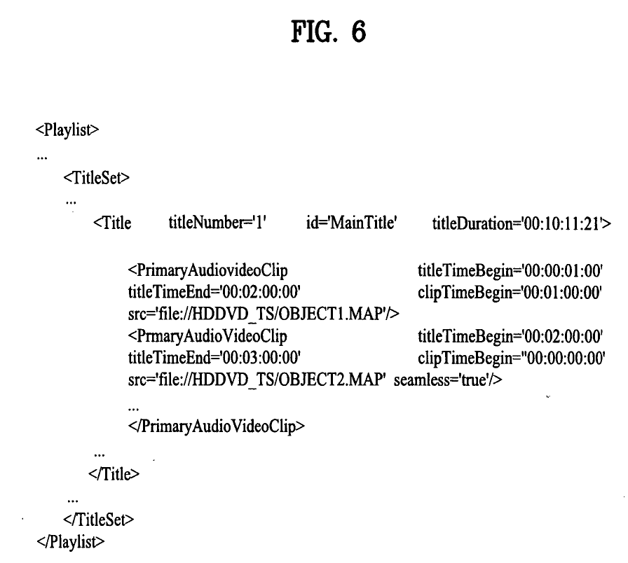

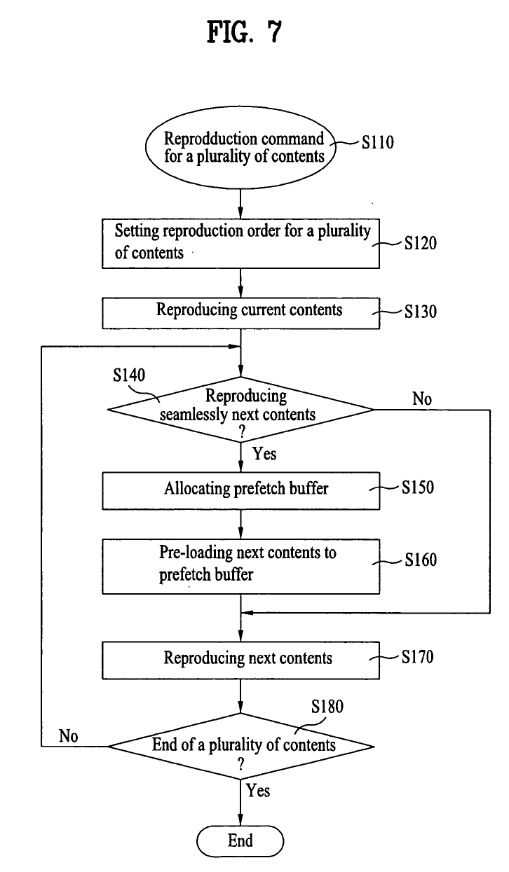

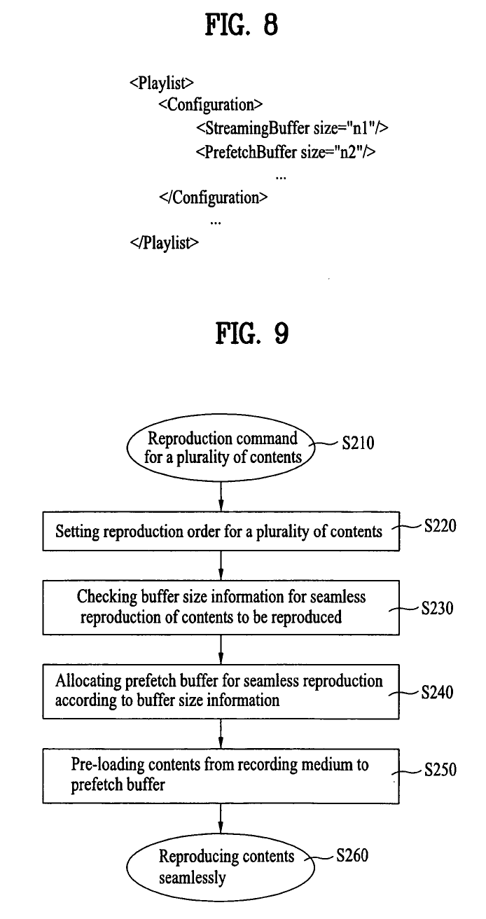

Besides, the seamless information and the buffer size information for a seamless reproduction can be included in a playlist. FIG. 6 and FIG. 7 show an example of a playlist including information indicating seamless information and a data reproducing flowchart using the seamless information, respectively. FIG. 8 and FIG. 9 show an example of a playlist including buffer size information for a seamless reproduction and a data reproducing flowchart using the buffer size information, respectively.

FIG. 6 is a diagram of seamless information according to one embodiment of the present invention.

An optical recording/reproducing apparatus according to the present invention is able to allocate a prefetch buffer for a seamless reproduction by checking whether contents should be seamlessly reproduced in reproducing a plurality of contents continuously. And, seamless information indicating whether contents should be seamlessly reproduced can be recorded in a recording medium to be provided to the optical recording/reproducing apparatus.

A playlist is able to include information of titles for advanced content. And, a title number (titleNumber), an identifier (id) and a title timeline are assigned to each of the titles. Advanced content presentation is managed based on a title timeline that is a master time defining a presentation schedule and synchronization relation between presentation objects. The title timeline is defined for a title of a logical reproduction period of data and defines a default reproduction sequence and timing relation between presentation objects for each title. A valid period of a presentation object to be reproduced is mapped to a title timeline in advance. And, playlist manager 530c and reproduction modules control a reproduction start time and a reproduction end time for each of the presentation objects according to a time progress of the time timeline.

Referring to FIG. 6, a title timeline duration of a title, of which title ID is ‘MainTitle’ and of which title number is ‘1’, is ‘00:10:11:21’.

A playlist shown in FIG. 6 includes ‘PrimaryAudioVideoClip’, which is a presentation clip for a primary video audio, as title information.

A presentation clip is the information indicating object mapping information of presentation object segments and track number assignments of elementary streams within each presentation object. There are presentation clips such as ‘PrimaryAudioVideoClip’, ‘SubstituteAudioVideoClip’, ‘SubstituteAudioClip’, ‘SecondaryAudioVideoClip’, ‘AdvancedSubtitleSegment’ and ‘ApplicationSegment’.

The ‘PrimaryAudioVideoClip’ represents a mapping of a presentation object on a time period within a title timeline and track number assignments of elementary streams within a primary enhanced video object (P-EVOB).

Each presentation clip is able to include a start time (titleTimeBegin) of a continuous fragment of a presentation object on a title timeline, an end time (titleTimeEnd) of the continuous fragment and information (clipTimeBegin) indicating a start position of a primary enhanced video object.

And, the playlist includes ‘src’ information that is position information of an index information file of a presentation object configuring the title.

For instance, in case of reproducing ‘PrimaryAudioVideoClip’ of which start time (titleTimeBegin) and end time (titleTimeEnd) of one continuous fragment of a primary audio video object are ‘00:01:00:00’ and ‘00:02:00:00’, respectively and if a start position of an enhanced video object represented by the ‘PrimaryAudioVideoClip’ is ‘00:01:00:00’, the optical recording/reproducing apparatus 10 reads a time map (TMAP) named ‘OBJECT1.MAP’ located below a directory ‘HDDVD_TS’ using “src=‘file://HDDVD_TS/OBJECT1.MAP’/”. By interpreting enhanced video object information (EVOBI) referred to by the ‘OBJECT1.MAP’, a proper enhanced video object defined in the ‘EVOBI’ can be accessed.

In the present invention, the playlist is able to include a flag indicating whether each presentation clip of a presentation object is seamlessly reproduced or not.

If the flag of next presentation clip is set to ‘true’, the optical recording/reproducing apparatus 10 allocates a prefetch buffer 520b prior to a reproduction of the next presentation clip while the reproduction of the current presentation clip is in progress. And, the optical recording/reproducing apparatus 10 reads to store data of the next presentation clip from a recording medium in advance. Once a reproduction time of the next presentation clip comes, the data stored in the prefetch buffer 520b is directly reproduced from the buffer or is loaded in the file cache 520a to be reproduced. This continues until the reproduction of the presentation clip to be reproduced is completed.

Meanwhile, information indicating whether contents should be reproduced after previous contents can be defined per contents to be reproduced. Therefore, if the flag of next presentation clip is set to ‘true’, the optical recording/reproducing apparatus previously loads to store data in a prefetch buffer by allocating the prefetch buffer while a reproduction of a current presentation clip is in progress. If the flag is set to ‘false’, a buffer for a seamless reproduction may not be allocated since it is unnecessary to pre-load data.

FIG. 7 is a flowchart of a data reproduction using seamless information.

Referring to FIG. 7, once a payback command for a plurality of contents is given by a user operation, API or the like (S110), the optical recording/reproducing apparatus 10 sets up a reproduction order of the contents (S120).

In this case, the playlist manager 530c within the optical recording/reproducing apparatus 10 is able to set the reproduction order using information included in a playlist. For example, the playlist manager 530c is able to set the reproduction order of the contents in a sequential, random or shuffle mode. The contents is reproduced according to the reproduction order.

During reproduction of current contents (S120), the playlist manager 530c confirms seamless information from the playlist and then checks whether the contents is seamlessly reproduced or not (S140). As mentioned in the foregoing description for FIG. 6, whether the contents is seamlessly reproduced or not can be defined for each of the contents.

In present invention, an optical recording/reproducing apparatus 10 can check seamless information of next contents and allocating prefetch buffer 520b for the next contents during reproduction of current contents. In this case, if seamless information for the next contents is set to ‘true’, the playlist manager 530c allocates the prefetch buffer 520b for the next contents (S150).

If seamless information for the contents is set to ‘false’, the prefetch buffer 520b may not be allocated. In this case, data is read to be reproduced from a recording medium when a reproduction time of next contents comes (S170)

And, the prefetch buffer 520b can be allocated per contents according to contents reproduction order. In this case, a size of the prefetch buffer 520b will be modified per contents to be seamlessly reproduced up to reproduction of last contents. And, the prefetch buffer 520 can be allocated to correspond to ‘PrefetchBuffer size’ that will be explained in the description of FIG. 8.

Subsequently, contents to be next reproduce (hereinafter called a next contents) is read from the recording medium 30 and is then stored in the prefetch buffer 520b (S160).

If a reproduction time of the next contents comes, the contents data in the prefetch buffer 520b is reproduced to seamlessly reproduce the next contents continuous from the previous contents (S170).

Besides, if the next contents is last contents to be reproduced (S180), the reproduction of a plurality of the contents is terminated after reproduction of the next contents. However, if the next contents is not last contents to be reproduced (S180) and contents next to the next contents needs to be seamlessly reproduced (S140), the prefetch buffer 520b is allocated and data is loaded in advance to be stored in the prefetch buffer 520b. The foregoing procedure is repeated until all the contents is reproduced.

Meanwhile, if the seamless information is set to ‘false’, a used may experience a seam of a contents reproduction in the reproduction process according to a reproduction sequence of a plurality of contents since a title timeline may be cut.

FIG. 8 is a diagram of buffer size information for a seamless reproduction between contents according to one embodiment of the present invention.

A recording medium author or contents provider is able to record buffer size information for a seamless reproduction of contents in a recording medium by including the information in a specific file (e.g., playlist) to consider the seamless reproduction of contents. And, the buffer size information for the seamless reproduction can be recorded in the recording medium by being defined per contents to be reproduced.

Referring to FIG. 8, a playlist includes streaming buffer size information (StreamingBuffer size). The playlist manager changes a configuration of the data cache 520 for a startup sequence of advanced content reproduction using the StreamingBuffer size.

If the StreamingBuffer size does not exist in the playlist, it means that a size of the streaming buffer 520c within the data cache 520 is zero. For instance, if a unit of the size is 2k bytes and if the StreamingBuffer size within the playlist is ‘n1’, the streaming buffer 520c within the data cache 520c will be allocated with a size of ‘n1*2k bytes’.

In the present invention, the playlist is able to include buffer size information (hereinafter named PrefetchBuffer size information) for a seamless reproduction.

The playlist manager 530c is able to allocate a prefetch buffer 520b according to the PrefetchBuffer size by checking the PrefetchBuffer size information from the recording medium. If a unit of the size is 2k bytes and if the StreamingBuffer size is ‘n2’, the prefetch buffer 520b will be allocated with a size of ‘n2*2k bytes’. Contents to be reproduced next is preloaded as many as a size of the prefetch buffer 520b and is then stored in the prefetch buffer 520b.

Besides, the playlist is able to include both of seamless information, as mentioned in the foregoing descriptions of FIG. 6 and FIG. 7, and the PrefetchBuffer size. In this case, only if the seamless information is set to ‘true’, the PrefetchBuffer size may be defined to be recorded in the playlist. A contents provider decides whether seamlessly reproduce the contents or not. In case of attempting to reproduce corresponding contents seamlessly, the contents provider is able to record the PrefetchBuffer size for the corresponding contents in the recording medium.

Meanwhile, if the prefetch buffer 520b is allocated within the data cache 520, a size of the file cache 520a is obtained from subtracting sizes of the streaming and prefetch buffers 520c and 520b from a size of the data cache 520.

FIG. 9 is a flowchart of a data reproduction using buffer size information for a seamless reproduction between contents.

Referring to FIG. 9, once a payback command for a plurality of contents is given by a user operation, API or the like (S210), the optical recording/reproducing apparatus 10 sets up a reproduction order of a plurality of the contents (S220).

The playlist manager 530c confirms buffer size information for a seamless reproduction of contents from a playlist (S230). The playlist manager 530c then allocates a prefetch buffer 520b according to the buffer size information (S230).

The buffer size information can be defined per contents to be reproduced. In this case, the playlist manager 530c is able to allocate the prefetch buffer 520b to correspond to a largest buffer size in the buffer size information (S240) or allocate the prefetch buffer 520b to correspond to a buffer size for contents to be reproduced next (S240). In the latter, the prefetch buffer size will be changed according to the reproduction order.

Contents to be reproduced next (hereinafter named a next contents) is read from the recording medium 3 in advance and is then stored in the allocated prefetch buffer 520b (S250). Once a reproduction time of the next contents comes, continuous seamless reproductions of the next contents can be implemented by reproducing the data stored in the prefetch buffer 520b (S260).

Besides, the prefetch buffer 520b, as mentioned in the foregoing description, can be allocated to the data cache 520 or defined in another intrinsic area.

In the foregoing description, it is explained that the allocation or change of the prefetch buffer 520b is managed by the playlist manager 530c. Alternatively, a prefetch manager can be provided to the optical recording/reproducing apparatus 10 as a separate control means for managing the prefetch buffer 530b.

And, it is also able to include both of the seamless information and the buffer size information for the seamless reproduction in the recording medium. The buffer size information may be included only if the seamless information is set to ‘true’.

In the present invention, the seamless reproduction between contents to be continuously reproduced can be implemented. And, in case that the primary enhanced video object comes from the recording medium, it is able to implement the seamless reproduction between contents which does not satisfy a specific condition that the primary enhanced video object is designated as one clip or that an enhanced video object connected to a preceding enhanced video object is contiguously allocated on the recording medium.

Accordingly, the present invention provides the following effects or advantages.

First of all, the present invention is able to implement a seamless reproduction between contents within a recording medium.

Secondly, the present invention enables a seamless reproduction between contents that are not contiguously recorded on a recording medium.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for reproducing a plurality of contents within a recording medium successively, the method comprising:
first reproducing a first contents among the contents;
allocating a buffer for seamless reproduction of a second contents in case that seamless information recorded on the recording medium indicates that the second contents is seamlessly reproduced after the first contents is reproduced;
pre-loading the second contents from the recording medium to the buffer; and
second reproducing the second contents pre-loaded in the buffer.

2. The method of claim 1, wherein the buffer is allocated according to buffer size information for the seamless reproduction.

3. The method of claim 1, wherein the buffer is allocated to a data cache within a player.

4. An apparatus for reproducing a plurality of contents within a recording medium successively, the apparatus comprising:
a pickup reading data from the recording medium; and
a controller controlling a first contents among the contents to be reproduced, the controller allocating a buffer for seamless reproduction of a second contents in case that seamless information recorded on the recording medium indicates that the second contents is seamlessly reproduced after the first contents is reproduced, the controller pre-loading the second contents from the recording medium to the buffer; and controlling the second contents pre-loaded in the buffer to be reproduced.

5. The apparatus of claim 4, wherein the controller allocates the buffer according to buffer size information for the seamless reproduction.

6. The apparatus of claim 4, wherein the controller allocates the buffer to a data cache within a player.

7. A recording medium comprising:
a stream area on which a plurality of contents is recorded; and
a management area on which reproduction management information of the contents is recorded,
wherein the reproduction management information includes seamless information indicating whether or not the contents is seamlessly reproduced.

8. The recording medium of claim 7, wherein the seamless information is defined for each of the contents.

9. The recoding medium of claim 7, wherein the reproduction management information further includes buffer size information for seamless reproduction of the contents.

10. The recording medium of claim 9, wherein the buffer size information is defined for each of the contents.

11. A method of recording data, comprising:
recording a plurality of contents on a recording medium; and
recording reproduction management information for the contents,
wherein the reproduction management information includes seamless information indicating whether or not the contents is seamlessly reproduced.

12. The method of claim 11, wherein the reproduction management information further includes buffer size information for seamless reproduction of the contents.

13. The method of claim 12, wherein the buffer size information is included in the reproduction management information in case that the seamless information indicates that the contents is seamlessly reproduced.

14. An apparatus for recording data, comprising:
a recording unit recording a plurality of contents on a recording medium; and
a controller generating reproduction management information including seamless information indicating whether or not the contents is seamlessly reproduced, the controller controlling the recording unit to record the reproduction management information on the recording medium.

15. The apparatus of claim 14, wherein the reproduction management information further includes buffer size information for seamless reproduction of the contents.

16. The apparatus of claim 15, wherein the buffer size information is included in the reproduction management information in case that the seamless information indicates that the contents is seamlessly reproduced.
